(19) United States
(12) Patent Application Publication
(10) Pub. No.: US 2003/0055741 A1
(43) Pub. Date: Mar. 20, 2003

(54) Server for exchanging design information, method for exchanging design information, program for exchanging design information, buying method of special design product and selling method of special design product

(75) Inventor: Takayuki Yamamoto, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 10/223,372

(22) Filed: Aug. 20, 2002

(30) Foreign Application Priority Data
Aug. 21, 2001 (JP) 2001-250543

(51) Int. Cl. G06F 17/60

(52) U.S. Cl. 705/26

(57) ABSTRACT

A server for exchanging design information, comprising: an editing module configured to edit items of individual design data concerning the design information of special design products, which was transmitted from the terminal units of a plurality of apparatus users via a communication network, into one common design data, and to reedit replies to the plurality of common design data, which was transmitted from the terminal units of a plurality of apparatus makers, into individual design data of each apparatus user; a comparison module configured to detect items on a design information sheet, which have been newly added to the individual design data; and a design data storage unit configured to store the items on the design information sheet, which have been newly added separately from default items on a design information sheet.

### CROSS REFERENCE TO RELATED APPLICATIONS

This application is based upon and claims the benefit of priority from prior Japanese Patent Application P2001-250543 filed on Aug. 21, 2001; the entire contents of which are incorporated by reference herein.

### BACKGROUND OF THE INVENTION

1. Field of the Invention

The present invention relates to an information exchange technology via a network, and more particularly to a design information exchange technology for use in buying sophisticated and high-priced special design products such as plants, machine tools, large-scale computers, analysis instruments, measurement instruments, and manufacturing apparatuses.

2. Description of the Related Art

Semiconductor device makers are apparatus users since the makers use a large number of semiconductor manufacturing apparatuses when semiconductor devices are manufactured. When apparatus users buy semiconductor manufacturing apparatus necessary for steps in the manufacturing of semiconductor devices, the apparatus users and apparatus makers exchange information relating to design of the manufacturing apparatus according to the following procedures, and then the users make decision as to whether the user buys the apparatus or not.

First, the apparatus users determine desired design concerning the manufacturing apparatus capable of realizing a target manufacturing processes. Then, the apparatus users make a list of several manufacturing apparatuses that can cope with the desired design. The apparatus users evaluate the capability, productivity and cost of the manufacturing apparatuses listed, and select a manufacturing apparatus that meets the desired design. At this time, the manufacturing apparatus having only functions incorporated thereon by the apparatus maker often do not satisfy the functions and performance desired by the apparatus user. For this reason, the apparatus user adds new design information relating to additional items to be described on a design information sheet, and presents this design information sheet to the apparatus maker. In addition, to meet the requests of the apparatus user, the apparatus maker prepares a response paper for the design concerning the apparatus, in which new parts, piping and instruments etc. are additionally built, and exchanges design information relating to the design.

As described above, the apparatus user presents the design information described on the design information sheet to the apparatus maker, and the apparatus maker replies to the desired design, thus exchanging the design information between the apparatus maker and the apparatus user. Therefore, when the apparatus user lines up a plurality of apparatus makers as candidates for the apparatus which the apparatus user wishes to buy, the apparatus user must present the design information described on the design information sheet to all the respective apparatus makers from which the apparatus user wishes to buy the apparatus. In addition, despite some items of common design information being included in the design information sheet due to the fact that the apparatuses, although manufactured by different apparatus makers are designed to perform the same processes, when the apparatus user presents the design information described on the design information sheet to different apparatus makers, the documentary form and composition of the design information file prepared are different for various reasons such as different backgrounds, different concepts of the design preparation for each apparatus maker, different constitutions and systems of principal parts, as well as for reason such as different persons being responsible for preparing the design information file. Accordingly, the apparatus user prepares separate design information files for the respective apparatus makers.

Furthermore, the design information described on the design information sheet is presented by a plurality of apparatus users to the apparatus maker. However, since the apparatus users respectively prepare the design information files describing the design information in the original documentary forms, the documentary forms are different among the apparatus users. Furthermore, in spite that the design information described on the design information sheet presented by each apparatus user is for the same apparatus, each apparatus user is unique in term of processes and know-how about the processes and the like, and each user pays attention to different points. Therefore, items on a design information sheet presented by the apparatus user, the composition of the design information file and the degree of detail are different depending on the design information sheet. Accordingly, the apparatus maker must compare the design information presented by the apparatus user with the design information described on the design information sheets that can be replied to by the apparatus maker, and must confirm the items on the design information sheet and the contents of the desired design. Then, the apparatus maker must prepare an individual response paper for the desired design of each apparatus user. Since different design information described on the design information sheet is presented by a plurality of apparatus users, this work must be conducted in such a manner that the items on the design information sheet and the contents of the desired design are separately confirmed for each apparatus user.

As described above, design information files described in different documentary forms and different compositions arrive from a plurality of apparatus users to the apparatus maker, and the design information file describing in the different documentary form and the different composition for replying to the apparatus user arrives to each of a plurality of apparatus users from a plurality of apparatus makers. Therefore, it is impossible for the individual apparatus user to prepare the design information file in a common documentary form in spite of the manufacturing/fabrication process, the measurement and the analysis, which are targeted, being identical to each other, and the apparatus user must deal with each individual apparatus maker respectively. There is a problem that the work is inefficient. Similarly, it is impossible for the apparatus maker to prepare the design information file in a common documentary form in spite of the apparatuses to be manufactured being identical, and the apparatus maker must deal with each individual apparatus users respectively, and there is a problem that the work is inefficient and takes considerable time.

### SUMMARY OF THE INVENTION

A first aspect of the present invention is to provide a server for exchanging design information comprising: a) an editing module configured to edit items of individual design data concerning the design information of special design products, which was transmitted from the terminal units of a plurality of apparatus users via a communication network, into one common design data, and to reedit replies to the plurality of common design data, which was transmitted from the terminal units of a plurality of apparatus makers, into individual design data of each apparatus user; b) a comparison module configured to detect items on a design information sheet, which have been newly added to the individual design data; and c) a design data storage unit configured to store the items on the design information sheet, which have been newly added separately from default items on a design information sheet.

A second aspect of the present invention is to provide a server for exchanging design information comprising: a) means for editing items of individual design data concerning the design information of special design products, which was transmitted from terminal units of a plurality of apparatus users via a communication network, into one common design data, and for reediting replies to the plurality of common design data, which was transmitted from the terminal units of a plurality of apparatus makers, into individual design data of each apparatus user; b) means for detecting items on a design information sheet, which have been newly added on the individual design data; and c) a design data storage unit for storing the items on the design information sheet, which have been newly added separately from default items on a design information sheet.

A third aspect of the present invention is to provide a method of exchanging design information comprising: a) registering a definition file concerning design information of a special design product in a design data storage unit; b) detecting items on a design information sheet, which have been newly added to individual design data transmitted from a terminal unit of each of a plurality of apparatus users via a communication network, and sorting the newly added design items on the design information sheet to store them in the design data storage unit; c) editing the individual design data transmitted from the terminal units of the plurality of apparatus users to one common design data; d) receiving replies to the common design data from terminal units of a plurality of apparatus makers via the communication network; and e) reediting the replies to the common design data into the individual design data of each apparatus user.

A fourth aspect of the present invention is to provide a computer program product to be executed by a computer for controlling a design information exchange server comprising: a) instructions configured to register a definition file concerning design information of a special design product in a design data storage unit connected to the server; b) instructions configured to detect items on a design information sheet, which are newly added on individual design data transmitted from a terminal unit of each of a plurality of apparatus users via a communication network, and to sort the newly added design items on the design information sheet to store them in the design data storage unit; c) instructions configured to edit the individual design data transmitted from the terminal units of the plurality of apparatus users to one common design data; d) instructions configured to receive replies to the common design data from terminal units from a plurality of apparatus makers via the communication network; and e) instructions configured to reedit replies to the common design data into individual design data of each apparatus user.

A fifth aspect of the present invention is to provide a method of buying a special design product comprising: a) receiving a definition file concerning design information of a special design product registered in a server via a communication network by a terminal unit of an apparatus user; b) transmitting individual design data in which contents of desired design are described for each item on the design information sheet on the definition file to the server via the communication network by the terminal unit of the apparatus user; c) receiving a reply to the individual design data, which is transmitted from a terminal unit of an apparatus maker to the server, from the server via the communication network by the terminal unit of the apparatus user; d) notifying of a wish to buy the special design product to the terminal unit of the apparatus maker via the server by the terminal unit of the apparatus user; e) receiving an estimate sheet of the special design product meeting desired design of the apparatus user via the server by the terminal unit of the apparatus user; and f) transmitting an order sheet corresponding to the estimate sheet to the apparatus maker via the server by the terminal unit of the apparatus user.

A sixth aspect of the present invention is to provide a method of selling a special design product comprising: a) receiving individual design data concerning design information of the special design product as common design data, which is edited and transmitted from a terminal unit of an apparatus user via a communication network, from the server via the communication network by a terminal unit of an apparatus maker; b) transmitting a reply to the common design data to the server via the communication network, and transmitting data, which is obtained by reediting the reply into individual design data, to the terminal unit of the apparatus user via the server by the terminal unit of the apparatus maker; c) receiving a estimate request of the special design product from the terminal unit of the apparatus user via the server by the terminal unit of the apparatus maker; d) transmitting an estimate sheet for the special design product to the terminal unit of the apparatus user via the server by the terminal unit of the apparatus maker; and e) receiving an order sheet transmitted from the terminal unit of the apparatus user via the server by the terminal unit of the apparatus maker.

### BRIEF DESCRIPTION OF THE DRAWINGS

FIG. 1 is a block diagram of a system according to a first embodiment of the present invention.

FIG. 2 is a block diagram of a server for exchanging design information of the first embodiment of the present invention.

FIGS. 3A and 3B are flowcharts showing a method of exchanging design information according to the first embodiment of the present invention.

FIG. 4 is a flowchart showing a buying/selling method of a special design product according to the first embodiment of the present invention.

FIG. 5 is a flowchart showing a method of exchanging design information according to a second embodiment of the present invention.

FIGS. 6A and 6B are flowcharts showing a method of exchanging design information according to a third embodiment of the present invention.

FIGS. 7A and 7B are flowcharts showing a method of exchanging design information according to a fourth embodiment of the present invention.

FIG. 8 is an example of a definition file according to the first embodiment of the present invention.

FIG. 9 is an example of individual design information data in which the contents of desired design are described by an apparatus user according to the first embodiment of the present invention.

FIG. 10 is an example of individual design information data in which items on a design information sheet are added by the apparatus user according to the first embodiment of the present invention.

FIG. 11 is a schematic view of an edition of common design information data according to the first embodiment of the present invention.

FIG. 12 is an example of common design information data sent in reply by an apparatus maker according to the first embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

(First Embodiment)

In a first embodiment, descriptions will be made for the case where by utilizing a system according to the present invention, a plurality of apparatus users (semiconductor device makers) who buy a semiconductor manufacturing apparatus as a special design product and a plurality of apparatus makers who sell semiconductor manufacturing apparatuses exchange design data for a specified semiconductor manufacturing apparatus (special design product).

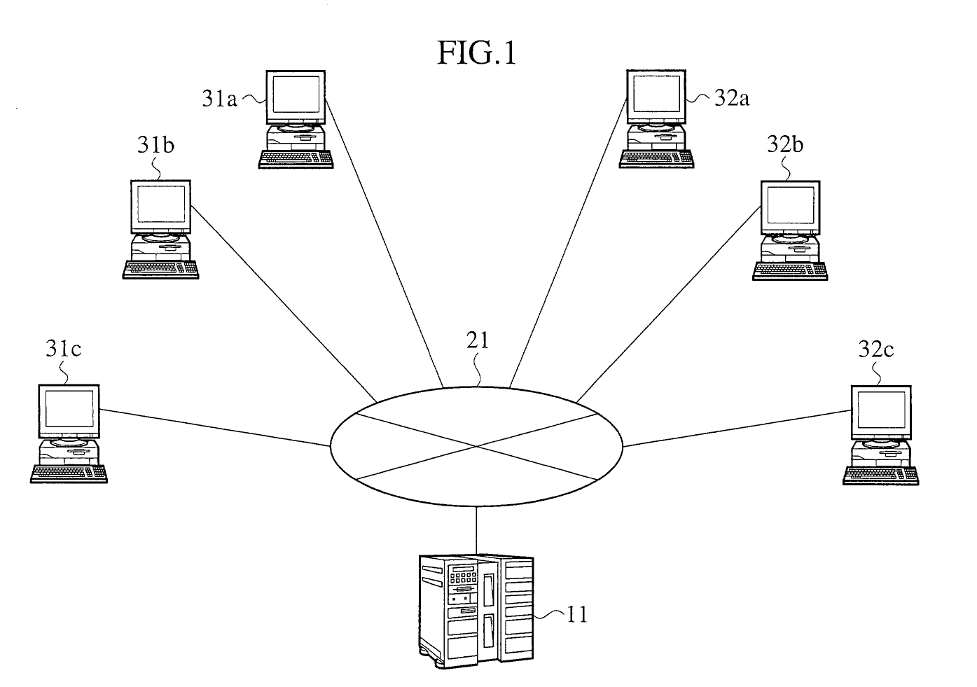

As shown in FIG. 1, a system according to the present invention comprises Internet (communication network) 21, a server for exchanging design information 11, which is connected to Internet 21, terminal units 31a, 31b, 31c . . . of a plurality of apparatus users, and terminal units 32a, 32b, 32c . . . of a plurality of apparatus makers. At this time, processing in the system are simplified by previously defining the description items, description methods and compositions of design data relating to the design of a special design product (herein, semiconductor manufacturing apparatus), which are to be exchanged, and a definition file previously defining the description items is used. In addition, though the definition file is described on the assumption that it is previously defined, the apparatus user, the apparatus maker or third parties, or consultative organizations may define the definition file. Furthermore, it is supposed that eXtendable Markup Language (XML) is used as the forms of the definition method and design data of the design of the special design product. However, no distinction is made for the forms.

In the present invention, data obtained by writing the contents of desired design to the definition file by the apparatus user is called “individual design data”, and data obtained by editing the individual design data into one design data is called “common design data”. Moreover, when the word “design data” is used, it simply means both of the individual design data and the common design data. “Communication network” means an information network (computer network) such as Local Area Network(LAN), Wide Area Network(WAN), Internet and Intranet. “Special design product” means products, which are improved and high price industrial products and of which a special design is required. Specifically, the special design product includes plants for chemical industries and steel industries, special edition high performance machine tools, special purpose large scale computers, analyzers such as secondary ion mass spectrometer (SIMS) and Rutherford back scattering instrument (RBS), special and high performance measurement instruments such as measurement instruments for milli-wave zone and sub-milli-zone, and manufacturing apparatuses such as semiconductor manufacturing apparatuses. “Apparatus user ” means makers who buy and use these special purpose products to create new industrial added values. The apparatus user registers the items on the design information sheet as to the special design product to be bought and the contents of the desired design for the items on the design information sheet in the individual design data. In addition, “apparatus maker” means maker who sells the above described special design product, and replies to the contents of design desired by the apparatus user on the common design data. The apparatus maker includes businesses such as sales agencies who are devoted to sales. The server for exchanging design information controls information exchange through design data between terminal units of the apparatus users and terminal units of the apparatus makers.

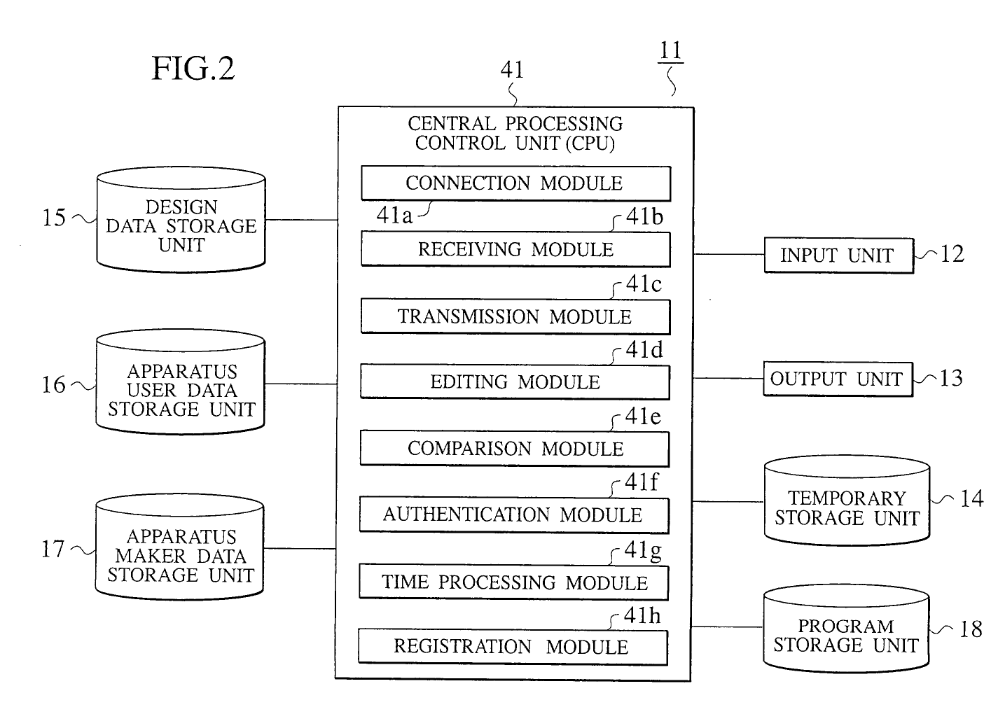

As shown in FIG. 2, the server for exchanging design information 11 comprises a central processing unit (CPU) 41, an input unit 12, an output unit 13, a temporarily storage unit 14, a design data storage unit 15, an apparatus user data storage unit 16, an apparatus maker data storage unit 17 and a program storage unit 18.

The central processing unit (CPU) 41 includes a connection module 41a, a receiving module 41b, a transmission module 41c, an editing module 41d, a comparison module 41e, an authentication module 41f, a time processing module 41g and a registration module 41h. The connection module 41a connects Internet 21 and the server for exchanging design information 11 to exchange data therebetween. The receiving module 41b receives the reply to the individual design data sent from the terminal units 31a, 31b, 31c, . . . of the apparatus users or the reply to the common design data sent from the terminal units 32a, 32b, 32c, . . . of the apparatus makers. Herein, the received design data is stored in the design data storage unit 15. The transmission module 41c transmits the definition file to the terminal units 31a, 31b, 31c, . . . of the apparatus users, and transmits the common design data to the terminal units 32a, 32b, 32c, . . . of the apparatus makers. The editing module 41d packs the items on the design information sheet and the contents of the desired design included in the individual design data sent from the apparatus users, and edits the common design data including all of the items on the design information sheet to which the apparatus maker replies. Furthermore, the editing module 41d edits the common design data, which is stored in the design data storage unit 15 and has been replied to by the apparatus maker, into individual design data in accordance with the items on the design information sheet for each apparatus user. The comparison module 41e compares the individual design data, in which the addition of the items on the design information sheet and the setting of the contents of the desired design were done by the apparatus user, with the definition file, and when the items have been added to the design information sheet, the comparison module 41e sorts the added the items on the design information sheet and stores them in the design data storage unit 15. The authentication module 41f decides whether the apparatus user who transmits/receives the data is one who has been registered previously by referring to data stored in the apparatus user data storage unit 16. In addition, the authentication module 41f decides whether the apparatus maker who transmits/receives the data is one who has been registered previously by referring to information stored in the apparatus maker data storage unit 17. The time processing module 41g checks incessantly whether a time previously registered has elapsed. When the registered time has elapsed, the time processing module 41g stops the receipt of the design data. The registration module 41h stores the registration information of the apparatus user including a user ID and a password in the apparatus user data storage unit 16, which is input thereto by use of the input unit 12. The registration module 41h stores the registration information of the apparatus maker including a user ID and a password in the apparatus maker data storage unit 17.

The input unit 12 indicates a device such as a keyboard and a mouse. When an inputting operation is performed by use of the input unit 12, corresponding key information is transmitted to the central processing control unit (CPU) 41. The output unit 13 indicates a screen such as a monitor, and a liquid crystal display device (LCD), a light emitting diode (LED) panel, and an electrouminescence (EL) panel or the like can be used for the output unit 13. The temporary storage unit 33 temporarily stores data and the like in the middle of an arithmetic operation and analyzing in the processing of the central processing control unit (CPU) 41.

The design data storage unit 15 stores the definition file, the individual design data, the common design data, the reply to the common design data and the like. The apparatus user data storage unit 16 stores user identification information such as a user ID and password of the apparatus user registered. In addition, the apparatus maker data storage unit 17 stores maker identification information such as a user ID and password of the apparatus maker registered. The program storage unit 18 stores programs for allowing the central processing control unit (CPU) 41 to execute the receiving/transmission of the design data, the storing/edition of the design data, and the registration of a system user or the like.

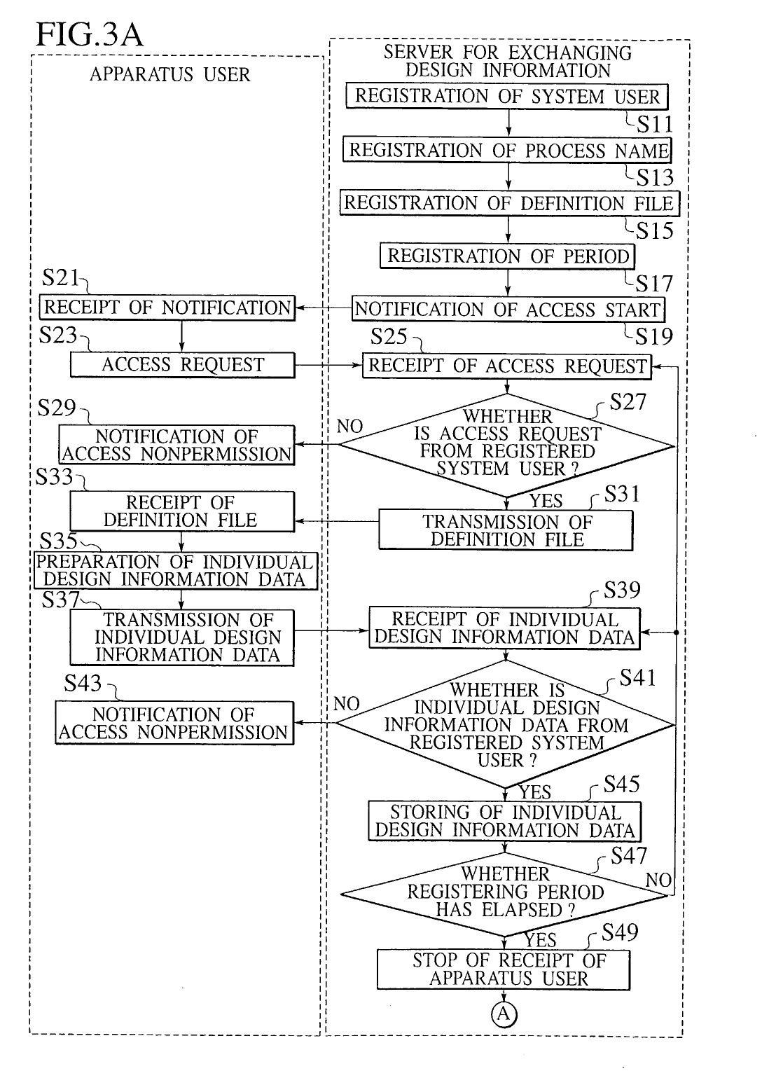

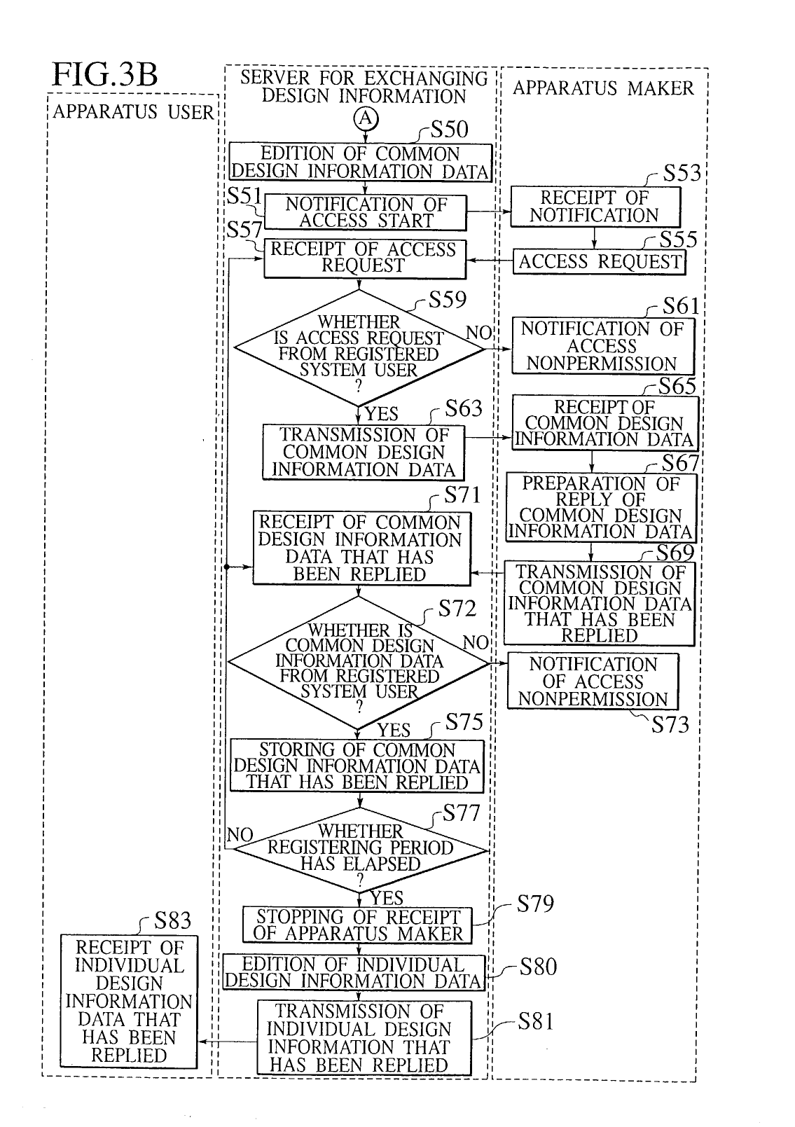

Next, a method of exchanging information will be described by use of FIGS. 3A and 3B.

(a) First, in step S11, a system user using the system according to the present invention is registered in the server for exchanging design information 11. The “system user” means the apparatus user and the apparatus maker. In general, the apparatus maker is specialized depending on purpose processes, and hence the apparatus maker often differs for each process. Therefore, the apparatus makers are registered separately in each process. When the apparatus maker and the apparatus user are registered, information for identifying the system users from others, which includes a system user name, a password and the like, is registered. In addition, when the system user name is registered, it is also registered whether the system user name indicates the apparatus user or the apparatus maker.

This registration is possible as occasion demands, and when a new system user is registered, the registration is asked to the organization managing the system, and the new system user acquires an access right to the system. The organization which manages this system maybe the apparatus user or the apparatus maker. Alternatively, this organization may be third parties which are not composed of either of apparatus users or apparatus makers.

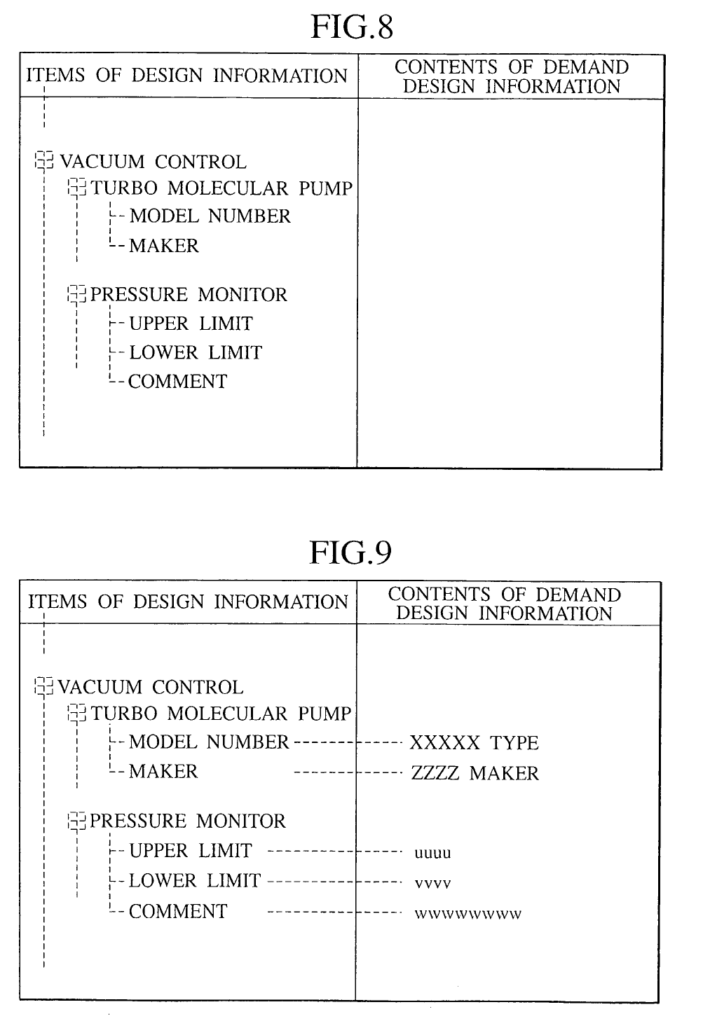

(b) Next, in step S13, the process name of the apparatus which performs the information exchange for the server for exchanging design information 11 is registered. This process name may be not only manufacturing process names such as an ion injection step, an oxide film Chemical Vapor Deposition(CVD) step, a plasma etching step, and a photolithograpy step but also semiconductor manufacturing apparatus name such as an ion injection apparatus, an oxide film CVD apparatus, a plasma etching apparatus and an exposure apparatus, which correspond to the process names. Next, in step S15, the definition file is stored in the design data storage unit 15 of the server for exchanging design information 11. The definition file is previously determined as described above. An example of this definition file is shown in FIG. 8. Items on a design information sheet meeting the process are set in the definition file. In FIG. 8, as the items on the design information sheet of an etching apparatus, the model number of a turbo molecular pump used for the vacuum control of a chamber, the upper and lower limits of a pressurizing monitor, and remarks are set. Next, in step S17, the period when the apparatus user writes the content of the desired design to the definition file and can set the individual design data is registered in the server for exchanging design information 11. The period when the apparatus maker can reply to the common design data is also registered therein.

(c) Subsequently, in step S19, the server for exchanging design information 11 notifies the registered apparatus users of an access start. As this notification method, the transmission of the access start to the apparatus users from the server for exchanging design information 11 by mail address is conceived. As a method of transmitting/receiving data among the terminal unit of the apparatus user and the server for exchanging design information as well as among the terminal unit of the apparatus maker and the server, the transmission by mail address is similarly conceived. At the time of this notification, the server for exchanging design information 11 notifies the apparatus user also of the period when the apparatus user can set individual design data. In step S21, the apparatus user receives notification of the access start, and, in step S23, performs an access request to the server for exchanging design information 11 to obtain the definition file. Simultaneously with this access request, the apparatus user transmits the apparatus user's name and the password to the server for exchanging design information 11. The server 11 receives the access request in step S25, and makes an authentication as to whether this apparatus user is a registered system user in step S27. This authentication is made by checking the apparatus user's name and the password, which were transmitted to the server 11, against the identification information of the apparatus user stored in the apparatus user data storage unit 16. If the apparatus user is not the registered system user, the server for exchanging design information 11 notifies the apparatus user of nonpermission for the access request in step S29. Furthermore, if the apparatus user is the registered system user, the server 11 transmits the requested definition file in step S31.

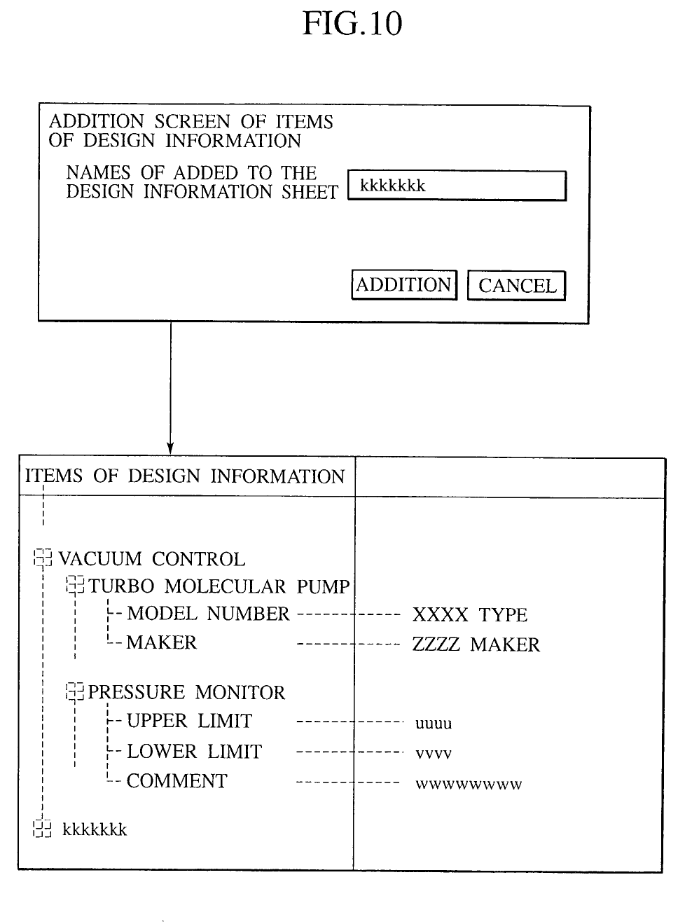

(d) Next, in step S33, the apparatus user receives a default definition file, and, in step S35, the apparatus user writes the contents of the desired design so as to correspond with the items on the design information sheet of the definition file, and sets the individual design data. FIG. 9 shows the individual design data in which the desired design of the apparatus user are written so as to correspond with the items on the design information sheet of the etching apparatus set in the definition file. In the items on the design information sheet, the model number of the turbo molecular pump used for the vacuum control of the chamber, the maker's name thereof, the upper and lower limits of the pressure monitor thereof and the remark are set. In the individual design data of FIG. 9, the apparatus user replies to the contents of the desired design including the model number: xxxxxxxx, the maker's name: zzz, the upper limit of the month of the monitor: uuuu, the lower limit of the motor: vvv, and the remark: wwwwwwww. As described above, though the items on the design information sheet in conformity with the process items are previously described in the default definition file, it is also possible for the apparatus user to add new items to the design information sheet. In this case, the items to be added to the design information sheet are decided by the screen shown in FIG. 10. In FIG. 10, the apparatus user adds new items on the design information sheet “kkkkkkk” in the text box to which “names of items added to the design information sheet name” is appended. After the new items on the design information sheet are described in the text box, the button “ADDITION” is clicked. Then, the items on the design information sheet “kkkkkkk” are added to the screen on which the design item list is displayed. Furthermore, when the button “CANCEL” is clicked, the names of the items on the design information sheet additionally described are canceled. It is possible for the apparatus user to set the individual design data by writing the contents of the desired design so as to correspond to the items newly added to the design information sheet.

(e) After the apparatus user prepares the individual design data, the apparatus user transmits the individual design data to the server for exchanging design information 11 in step S37, and at the same time, the apparatus user transmits also the name of the apparatus user and the password to the server 11. In step S39, the server for exchanging design information 11 receives the individual design data, and, in step S41, performs the authentication based on the apparatus user's name and the password as to whether the apparatus user is a registered system user, similarly to step S27. If the apparatus user is not a registered system user, the server 11 notifies the apparatus user that the apparatus user is not the registered system user. If the apparatus user is the registered system user, the server 11 stores the individual design data in the design data storage unit 15 in step S45. At this time, when the items on the design information sheet which do not exist in the default definition file exist in the individual design data, in other words, when there are the items on the design information sheet newly added by the apparatus user, the added the items on the design information sheet are sorted to be stored.

(f) Next, in step S47, it is checked whether a registration period of the individual design data by the apparatus user has elapsed. If the registration period thereof has not elapsed, the server 11 enters a state where the access request (S25) is waited for or in a state where the individual design information data receipt (S39) is waited for.

By iterating steps S25 to S45, the server for exchanging design information 11 receives the individual design data from the plurality of apparatus users.

(g) In step S47, if the registration period has elapsed, the server stops the acceptance of the individual design data of the apparatus user. Although FIG. 3A shows that the checking of the registration period is conveniently conducted at a timing of step S47, the checking is not limited to this timing. After the server for exchanging design information 11 notifies the access start to the apparatus user (S19), the server 11 incessantly checks the registration period, and the server 11 can stop to accept the individual design data from the apparatus user at any time.

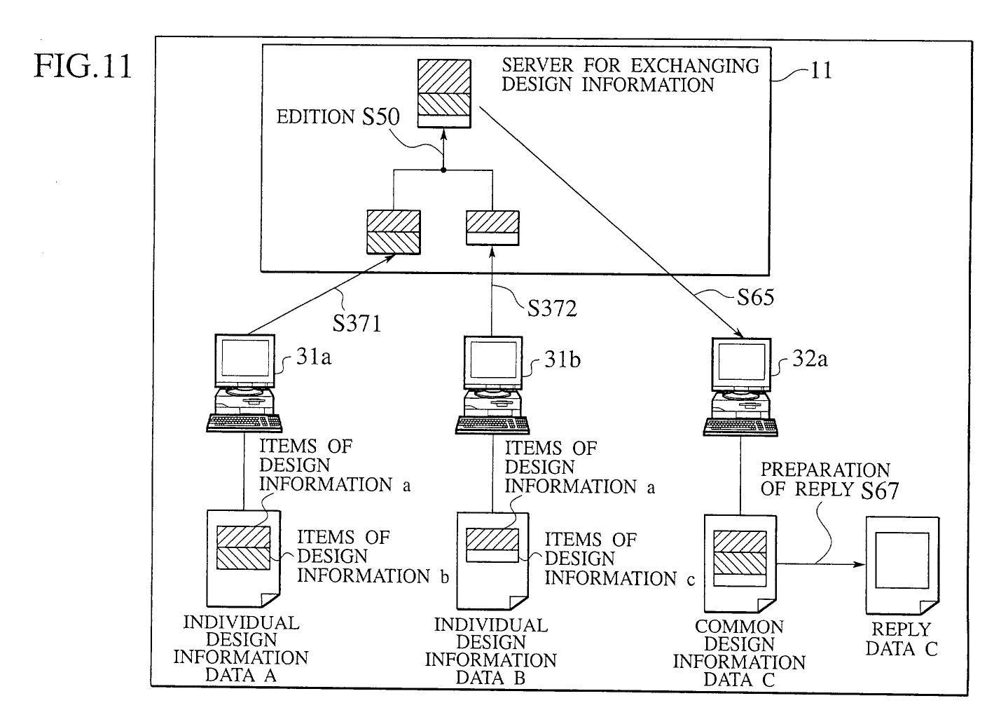

(h) After the server 11 stops to accept the individual design data from the apparatus user, the server 11 edits the individual design data sent from the apparatus user in step S50 of FIG. 3B. The details are illustrated in FIG. 11. FIG. 11 is a schematic diagram illustrating that two apparatus users which are companies transmit individual design data respectively prepared to the server for exchanging design information 11 by use of the terminal units 31a and 31b, and one apparatus maker receives common design data by use of the terminal unit 32a. The items on the design information sheet on the individual design data A and B and the common design data C are default items on the design information sheet initially registered in the definition file, and a item on the design information sheet b is an item newly added to the design information sheet of the individual design data A by the apparatus user who has the terminal unit 31a. Furthermore, an item on the design information sheet c is an item on the design information sheet newly added by the apparatus user who has the terminal unit 31b on the individual design data A. The individual design data A and the individual design data B are transmitted to the server for exchanging design information 11 via the terminal units 31a and 31b of the apparatus users (S371 and S372). The server for exchanging design information 11 which received the individual design data A and B executes an authentication processing for the apparatus users, and thereafter the server 11 allows the design data storage unit 15 to store the individual design data A and B therein. At this time, the default item on the design information sheet a, and the newly added items on the design information sheet b and c are sorted to be stored. In step S50, the individual design data A and the individual design data B, which are stored in the design data storage unit 15, are edited, and the common design data C including the item on the design information sheet a, the item on the design information sheet b and the item on the design information sheet c is prepared. The apparatus maker terminal unit 32a receives the common design data C (S65), and the apparatus maker replies to all the items on the design information sheet a, the items on the design information sheet band the item on the design information sheet c (S67).

(i) Next, in step S51 of FIG. 3B, the server for exchanging design information 11 notifies the access start to each of the apparatus makers registered. At the time of this notification, the server 11 further notifies the process name in which design information exchange is performed and also the period of time when the apparatus maker can reply to the common design data of each of the apparatus makers. In step S53, the apparatus maker receives the notification of the access start, and makes the access request to the server for exchanging design information 11 to acquire the common design data in step S55. Simultaneously with the access request, the apparatus maker transmits the user's name and the password to the server for exchanging design information 11. The server 11 receives the access request in step S57, and performs an authentication as to whether the apparatus maker is a registered system user in step S59. This authentication is performed by checking the apparatus maker's name and the password, which are transmitted to the server 11, against the information about the apparatus maker stored in the apparatus maker data storage unit 17. If the apparatus user is not the registered system user, the server for exchanging design information 11 notifies the apparatus maker of a nonpermission response to the access request in step S61. Furthermore, if the apparatus maker is a registered system user, the server 11 transmits the requested common design data in step S63.

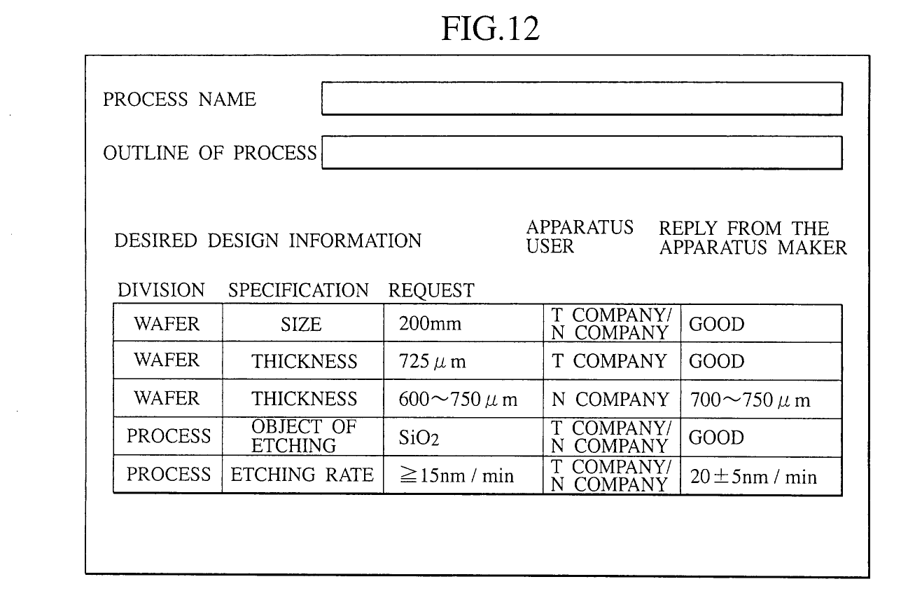

(j) Next, in step S65, the apparatus maker receives the common design data (corresponding to the common design data C in FIG. 11) which includes all items on the design information sheet (corresponding to the item on the design information sheet a, the items on the design information sheet b and the items on the design information sheet c in FIG. 11) described in the individual design data. In step S67, the apparatus maker prepares a reply to all items on the design information sheet in the common design data. FIG. 12 is an example of the reply to the common design data by the apparatus maker. In the common design data, the desired design obtained by editing the process name, the process outline and the items on the design information sheet are described. The items on the design information sheet are sorted into the division column, the design column and the request column. In FIG. 12, wafer and process divisions are described in the division column, wafer size, wafer thickness, an etching object and an etching rate are described in the design column, and the wafer size of 200 mm, the wafer thickness of 725 μm, the wafer thickness of 600 to 750 μm, the etching object SiO₂, and the etching rate of 15 nm/min or more are described in the request column. In the request design column, the apparatus user's names (T Company and N Company) which present the requests for the items on the design information sheet are also described. The apparatus maker replies to the requests for the items on the design information sheet in the apparatus maker reply column. In FIG. 12, in the apparatus maker reply column for the items on the design information sheet on the first row, the apparatus maker makes the reply to the effect that the requested wafer size of 200 mm is “good”. In addition, in the apparatus maker reply column for the items on the design information sheet on the second row, the apparatus maker replies to the effect that the requested wafer thickness of 725 μm is “good”. Still furthermore, in the apparatus maker reply column for the design items on the third row, the apparatus maker replies regarding the requested wafer thickness of 600 to 750μm, which informs the apparatus user the that the wafer thickness of 700 to 750 μm is “good”. Moreover, in the apparatus maker reply column for the items on the design information sheet on the fourth row, the apparatus maker replies to the effect that the request etching object SiO₂ is “good”. Still furthermore, in the apparatus maker reply column for the items on the design information sheet on the fifth row, the apparatus maker replies to the requested etching rate of 15 nm/min or more, which informs the apparatus user the that the etching rate of 20±5 nm/min is “good”. FIG. 12 shows one reply example, and the formats and the contents can be optionally edited by the editing module 41d of the server for exchanging design information 11 based on the data stored in the design data storage unit 15.

(k) After the apparatus maker prepares the reply to the desired items on the design information sheet in the common design data, in step S69, the apparatus maker transmits the common design data with the responses to the apparatus user, to the server for exchanging design information 11, and, at the same time, the apparatus maker transmits the apparatus maker's name and the password. In step S71, the server for exchanging design information 11 receives the common design data which has been sent back to the apparatus user, and, in step S72, the server 11 executes an authentication based on the apparatus maker's name and the password similarly to step S59 as to whether the apparatus maker is a registered system user. If the apparatus maker is not a registered system user, the server 11 notifies the apparatus maker that the apparatus maker is not the registered system user in step S73. If the apparatus maker is a registered system user, the server 11 allows the design data storage unit 15 to store the common design data which has been sent back to the apparatus user.

(1) Next, in step S77, the server 11 checks whether the registration period has elapsed. If the registration period has not yet elapsed, the server 11 enter a state where the access request (S57) is waited for or in a state where the receipt of the common design data which has been replied to (S71) is waited for. By iterating steps S57 to S75, the server for exchanging design information 11 receives the common design data from the plurality of apparatus makers which have replied to the apparatus users.

(m) In step S77, if it is decided that the registration period has already elapsed, the server 11 stops the acceptance of the apparatus maker in step S79. Although FIG. 3B shows that the checking of the registration period is conveniently conducted at the timing of step S77, the checking is not limited to this timing. After the server for exchanging design information 11 notifies the access start to the apparatus maker (S51), the server 11 incessantly checks the registration period, and the server 11 can stop accepting the replies to the common design data from the apparatus maker at any time.

(n) After the server 11 stops the acceptance of the apparatus maker responses, the server 11 edits the common design data, which have been replied to, to the individual design data for each apparatus user in step S80. Next, in step S81, the server 11 transmits the individual design data which has been replied to the apparatus users. The individual design data which has been transmitted corresponds to the items on the design information sheet of the apparatus users. For example, in FIG. 11, though the apparatus maker replies to all of the items on the design information sheet a, b and c by use of the common design data C, the individual design data transmitted to the apparatus user terminal unit 31a is the individual design data A replying to the items on the design information sheet a and b. The individual design data transmitted to the apparatus user terminal unit 31b is the individual design data B replying to the design items a and c. In step S83, each of the apparatus users (semiconductor device makers) receive the individual design data which has been replied to, and the exchange of design information for the process names that were first registered is completed.

By the method of exchanging the design information according to the first embodiment, the apparatus user can present the contents of the design to a plurality of apparatus makers. Therefore, it is possible to reduce cost which was spent for investigations because the apparatus user prepared different design information sheets for the respective apparatus makers. Particularly, since the comparable items are unified, the preparation of the list describing performance and design of the different apparatus makers is easy, and objective comparisons are possible. On the other hand, the apparatus maker can make an effective reply to the design information described on the design information sheet presented by the plurality of apparatus users by use of the common design data. Therefore, it is possible to decrease costs spent on the preparation of replies due to the apparatus maker making different replies for the respective apparatus users. Furthermore, since the period when the individual design data can be registered and the period when the reply to the common design data can be made are provided, the apparatus user can obtain a reply within a predetermined period. Since the periods are clear, it will be advantageous for the apparatus user to establish a production plan for producing products by use of an apparatus which the apparatus user considers to buy. In addition, in the past, when the apparatus user buys products, the apparatus user was apt to buy products from a fixed apparatus maker, the apparatus user can now consider the purchase of products manufactured by many apparatus makers including apparatus makers who have newly entered into the market, by use of the method of exchanging design information according to the first embodiment. On the other hand, the apparatus maker can possess a possibility of obtaining new customers by registering the design information in the server for the exchange of design information. The registration of the design information in the server for exchanging design information imparts chances to enter the market to both the apparatus user and the apparatus maker.

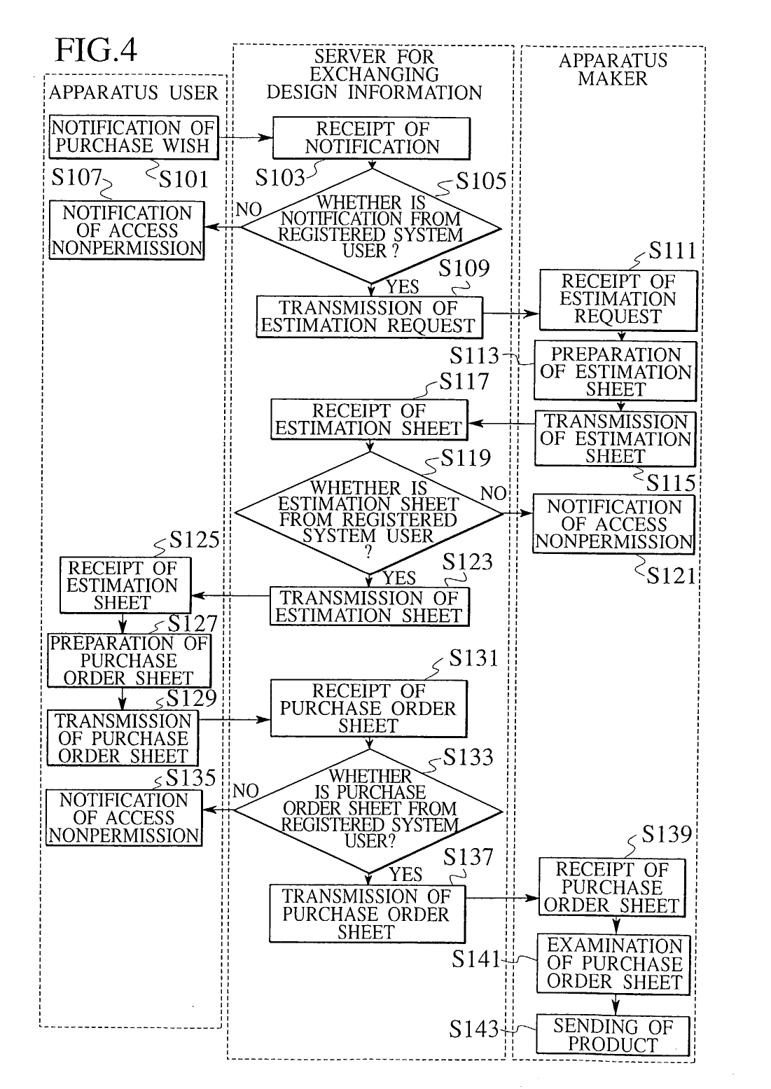

When the apparatus user wishes to buy a product after the exchange of the design information, the apparatus user can buy the product via the server for exchanging design information 11. A method of buying and selling products will be described by use of FIG. 4.

(a) First, in step S101, the apparatus user notifies the server for exchanging design information 11 that the apparatus user wishes to buy the product. In step S103, the server for exchanging design information 11 receives the notification, and, in step S105, the server 11 executes an authentication as to whether the apparatus user is a registered system user. This authentication is executed by checking the apparatus user's name and password, which was transmitted to the server 11, against identification information about the apparatus user stored in the apparatus user data storage unit 16. If the apparatus user is not the registered system user, the server 11 notifies the apparatus user of a nonpermission response to the access request in step S107.

(b) If the apparatus user is a registered system user, the server 11 transmits, to the apparatus maker, the notification that the apparatus user has made a request for an estimate for buying the product, in step S109. At this time, the server transmits the apparatus user's name and individual design data for the apparatus user who makes an estimate request of the apparatus maker. In step S111, the apparatus maker receives the apparatus user's name and individual design data of the apparatus user who is making an estimate request, and prepares the estimate sheet in step S113. This estimate sheet is prepared by computing the cost in consideration of the individual design data for the apparatus user who has made the estimate request. In step S115, the apparatus maker transmits the estimate sheet to the server for exchanging design information 11.

(c) Next, in step S117, the server for exchanging design information 11 receives the estimate sheet from the apparatus maker, and, in step S119, executes an authentication as to whether the apparatus maker is a registered system user. This authentication is executed by checking the apparatus maker's name and password, which were transmitted from the apparatus maker, against the identification information about the apparatus maker stored in the apparatus maker data storage unit 17. If the apparatus maker is not the registered system user, the server 11 notifies the apparatus maker of a nonpermission response to the access request in step S121.

(d) If the apparatus maker is a registered system user, the server 11 transmits the estimate sheet to the apparatus user in step S123. In step S125, the apparatus user receives the estimate sheet, and the apparatus user prepares an order sheet corresponding to the estimate sheet in step S127. In the order sheet, the approval of the cost described in the estimate sheet and the presentation of a cost lower than that described in the estimate sheet are described. In step S129, the apparatus user transmits the order sheet to the server for exchanging design information 11.

(e) Next, in step S131, the server 11 receives the order sheet, and, in step S133, executes an authentication as to whether the apparatus user is a registered system user. This authentication is executed by checking the apparatus user's name and password, which were transmitted from the apparatus user, against the identification information about the apparatus user stored in the apparatus user data storage unit 16. If the apparatus user is not the registered system user, the server 11 notifies the apparatus user of a nonpermission response to the access request in step S135.

(f) If the apparatus user is a registered system user, the server 11 transmits the order sheet of the apparatus user to the apparatus maker in step S137. In step S139, the apparatus maker receives the order sheet, and examines the contents of the order sheet in step S141. When the contents of the estimate sheet presented by the apparatus maker are approved in the order sheet, the apparatus maker sends the product to the apparatus user in step S143. When an objection to the estimate sheet prepared by the apparatus maker is given in the order sheet from the apparatus user, the apparatus maker prepares an estimate sheet again, and the apparatus maker may transmit the new estimate sheet to the apparatus user via the server for exchanging design information 11. When the apparatus maker cannot agree to the order sheet, the apparatus maker may transmit, to the apparatus user via the server for exchanging design information, the answer to the effect that the apparatus maker cannot sell the product. In addition, the apparatus user basically pays the price of the product to the apparatus maker by the method designated by the apparatus maker.

As described above, when the buying and selling of the special design product are performed via the server for exchanging design information 11, since the individual design data of the product is previously stored in the server for exchanging design information 11, design information described on the design information sheet of the special design product to be bought and sold becomes apparent. Since the individual design data is the design information previously presented by the apparatus user and the apparatus maker, it is possible to avoid trouble due to erroneous recognition of design information described on the design information sheet after the product is bought. Furthermore, when the special design product was bought/sold in the past, both the apparatus user and the apparatus maker had to perform troublesome procedures in which the apparatus user told the apparatus maker that the apparatus user wished to buy the special design product, and the apparatus maker explained the product to the apparatus user to make detailed arrangements about the design information described on the design information sheet for the product. However, this embodiment can omit these procedures by use of the system according to the present invention, leading to a decrease in a cost.

(Second Embodiment)

A constitution of a system according to a second embodiment of the present invention will be the same as that of the first embodiment shown in FIG. 1. In the second embodiment, descriptions will be made for also the case where a plurality of apparatus users who consider buying semiconductor manufacturing apparatuses and a plurality of apparatus makers who sell semiconductor manufacturing apparatuses use the system, and exchange design information described on a design information sheet for the semiconductor manufacturing apparatus. In the second embodiment, inquiries to system users as to whether system users wish to take part in the exchange of design information are made before the exchange of the information, and the exchange of the information is executed with limitation to the system users who register the participation in the exchange of the design information.

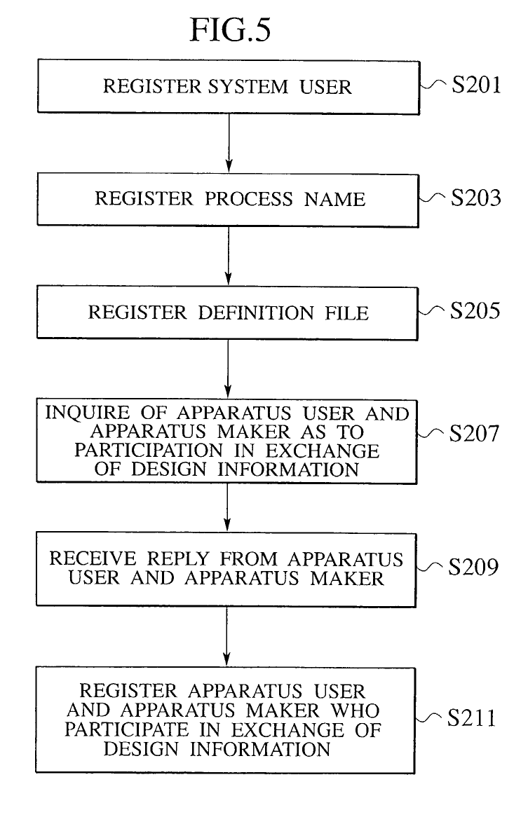

FIG. 5 is a processing flowchart of the server for exchanging design information 11 according to the second embodiment.

(a) First, in step S201, the server 11 registers the system user (apparatus user and apparatus maker) using the system according to the present invention. Next, in step S203, the server 11 registers the process name in which the exchange of the design information is executed. Subsequently, in step S205, the server 11 registers the definition file to be used. Steps S201 to S205 are the same as those in steps S11 to S15 of FIG. 3A described in the first embodiment.

(b) Next, in step S207, inquiries to the registered apparatus users and makers as to whether the apparatus users and makers wish to take part in the exchange of information relating to the registered process name are made. The apparatus users and makers respectively consider whether they will take part in the exchange of information, and transmit the results of their consideration to the server for exchanging design information 11. In step S209, the server 11 receives the replies from the apparatus users and the apparatus makers, and stores the apparatus users and makers, who expressed the participation in the exchange of the information, in the apparatus user data storage unit 16 and the apparatus maker data storage unit 17, respectively in step S211.

(c) The flows after step S211 are the same as those after step S19 of FIG. 3A according to the first embodiment. However, in the steps (S47 and S77) in which the elapse of the registration period of FIG. 3A is judged, it is decided whether replies from all of the registered apparatus users and all of the registered apparatus makers have been made. Actually, since an indefinite wait for the replies from all of the registered apparatus users and makers hinders prompt processing, the registration deadline may be provided. Specifically, the server for exchanging design information 11 may stop the acceptance of the apparatus users and makers depending on whether all of the registered system users made replies or whether the registration deadline has elapsed.

By the method of exchanging design information according to the second embodiment, the apparatus user can simultaneously present the contents of the design to the plurality of registered apparatus makers, and the apparatus maker can effectively reply to the design information described on the design information sheet presented by the plurality of registered apparatus users. Furthermore, only the system users who previously expressed a desire to participate in the exchange of information can use the system, whereby the design data can be effectively exchanged and disclosures of unnecessary design data can be suppressed.

(Third Embodiment)

A constitution of a system according to a third embodiment of the present invention is the same as that of the first embodiment shown in FIG. 1. The system according to the third embodiment is a system capable of disclosing items on the design information sheet and contents of desired design only to an apparatus maker designated by the apparatus user and capable of disclosing a reply to design data only to an apparatus user designated by the apparatus maker, by use of the method of exchanging design information of the first and second embodiments.

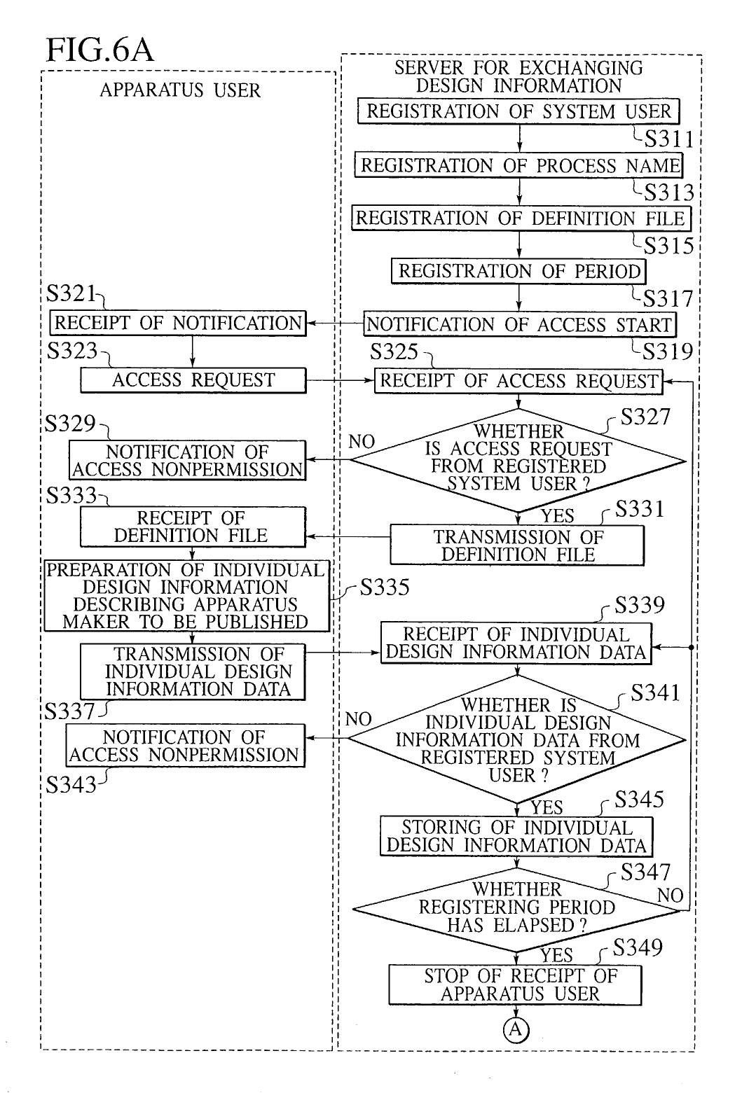

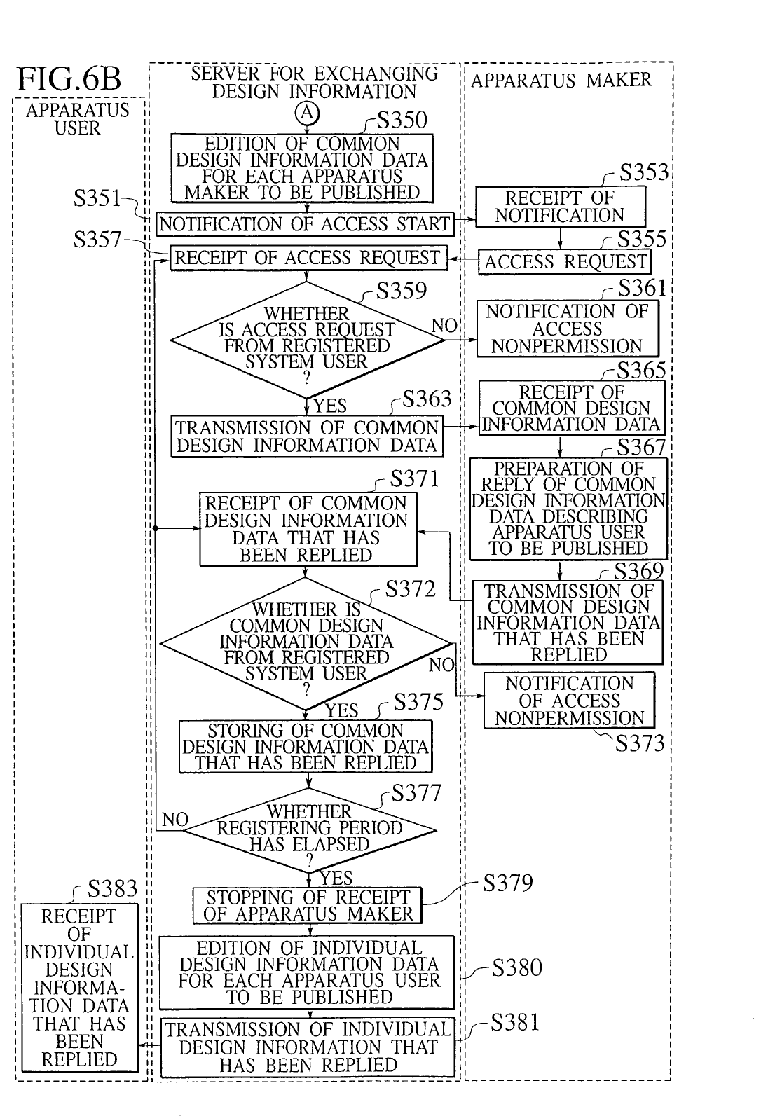

FIGS. 6A and 6B are processing flowcharts of a server 11 for exchanging design information of the third embodiment.

(a) First, steps S311 to S313 are the same as those in steps S11 to S13 described in FIG. 3A described in the first embodiment. Next, in step S315, the definition file is registered in the design data storage unit 15 of the server for exchanging design information 11. In this definition file, in addition to the contents described in the first embodiment, the description column of the apparatus maker's name to be disclosed is provided for the items on the design information sheet and the contents of the desired design, which the apparatus user sets, and the description column of the apparatus user's name to be disclosed is provided for the reply to the contents of the design, which the apparatus maker sets. Processing of steps S317 to S333 are the same as those in steps S17 to S33 of FIG. 3A described in the first embodiment.

(b) Next, in step S335, when the apparatus user describes the items on the design information sheet and the contents of the desired design in the definition file received from the server for exchanging design information 11, the apparatus user describes the disclosed apparatus maker's names for each of the items on the design information sheet and each of the contents of the desired design. Processing of steps S337 to S349 are the same as those in steps S37 to S49 of FIG. 3A described in the first embodiment.

(c) Next, in step S350, the server for exchanging design information 11 edits the common design data for each apparatus maker to be disclosed, based on the individual design data sent from each apparatus user. Processing of steps S351 to S361 are the same as those in steps S51 to S61 of FIG. 3B described in the first embodiment.

(d) Subsequently, in step S363, the server for exchanging design information 11 transmits the common design data edited for each disclosed apparatus maker corresponding to the apparatus maker who makes a request. In step S365, the same processing as that in step S65 of FIG. 3B described in the first embodiment is executed. Next, in step S367, the apparatus maker prepares the reply to all of the items on the design information sheet in the common design data. At this time, the apparatus user's name which discloses the reply is described. In steps S369 to S379, the same processes as those in steps S69 to S79 of FIG. 3B described in the first embodiment are executed.

(e) Next, in step S380, the server for exchanging design information 11 edits the common design data that has been replied to the individual design data for each apparatus user disclosed. The processing of steps S381 to S383 are the same as those in steps S81 to S83 of FIG. 3B described in the first embodiment.

According to the third embodiment, it is possible to limitedly disclose the items on the design information sheet, the contents of the desired design, and the reply thereto, and secrecy of information can be secured.

(Fourth Embodiment)

A constitution of a system according to a fourth embodiment is the same as that of the first embodiment shown in FIG. 1. The system according to the fourth embodiment is a system capable of disclosing no apparatus user's name and, no apparatus maker's name on the design data among the items on the design information sheet designated, by use of the method of exchanging design information described in the first and second embodiments.

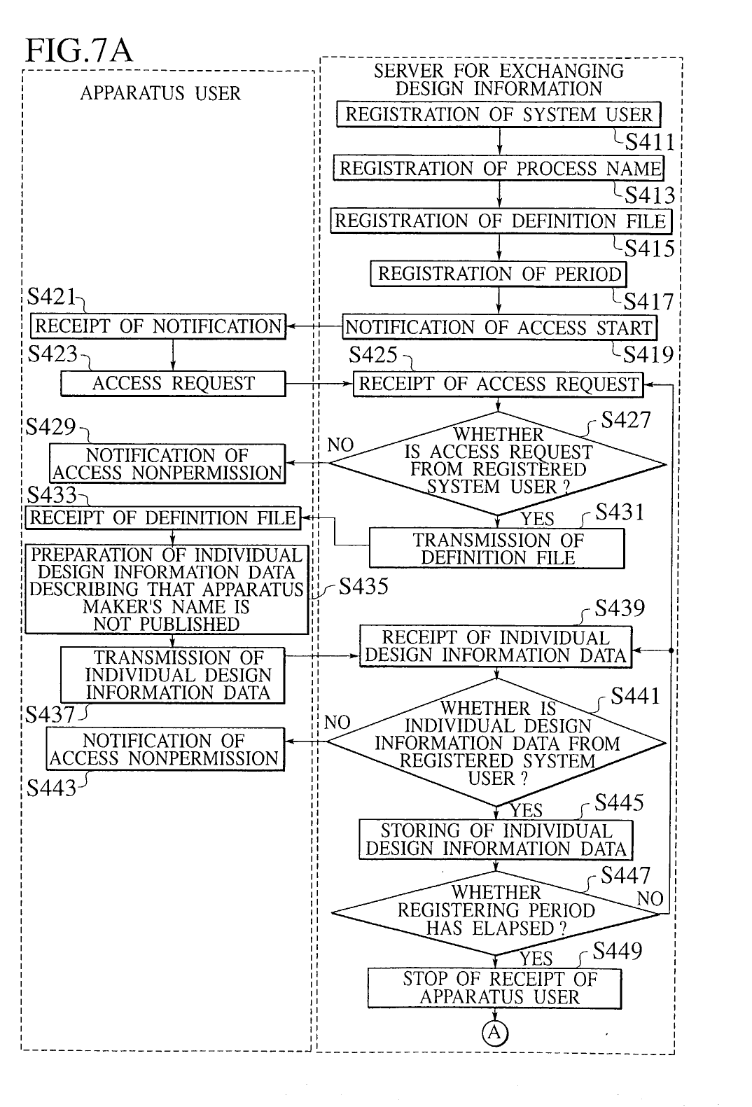

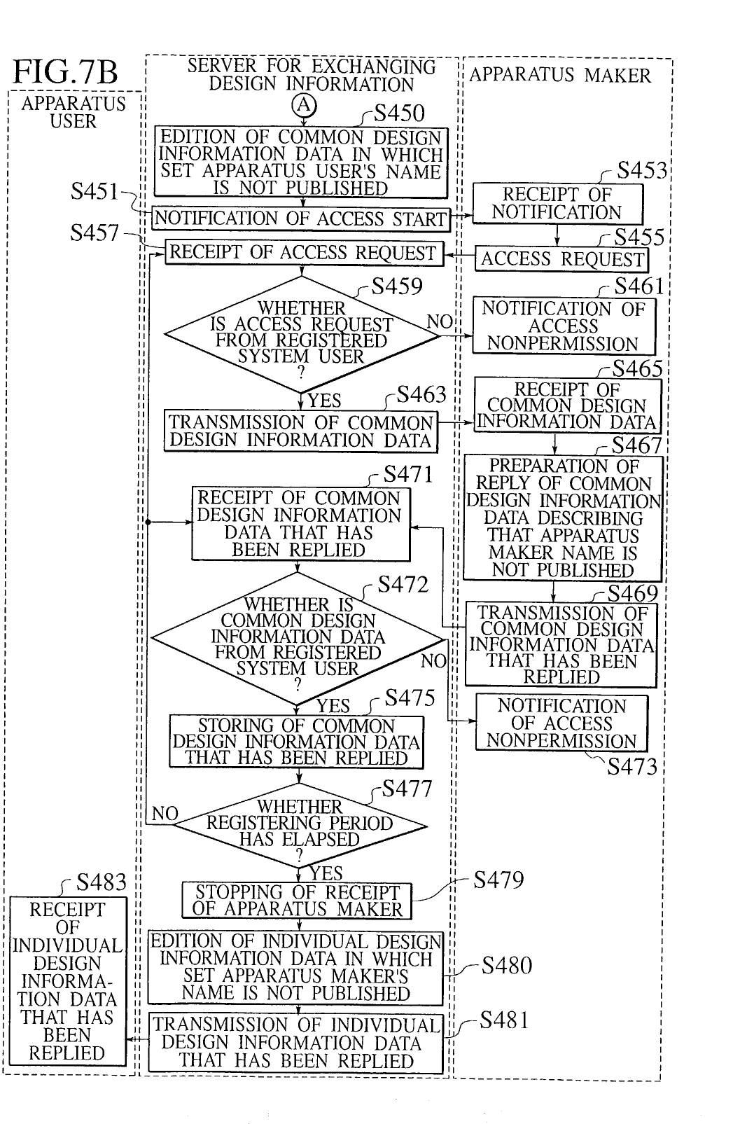

FIGS. 7A and 7B are flowcharts showing processing of the server for exchanging design information 11 according to the fourth embodiment.

(a) First, processing of steps S411 to S413 are the same as those in steps S11 to S13 of FIG. 3A described in the first embodiment. Next, in step S415, the definition file is registered in the design data storage unit 15 of the design information exchange unit 11. In this definition file, in addition to the contents described in the first embodiment, provided is a description column in which matter to the effect that an apparatus user which was set is not disclosed with regard to the items on the design information sheet and the contents of the desired design on the individual design data set by the apparatus user is described. With regard to a reply to the common design data replied by the apparatus maker, a description column is also provided, in which matter to the effect that an apparatus maker's name which replied to the common design data is not disclosed is described. The description columns describing the matter to the effect that no publication is made takes a check box form, and a constitution may be adopted, in which a corresponding check box is checked off when no publication is made. The processing of steps S417 to S433 are the same as those in steps S17 to S33 of FIG. 3A described in the first embodiment.

(b) Next, in step S435, when the apparatus user describes the items on the design information sheet and the contents of the desired design in the definition file received from the server for exchanging design information, the apparatus user describes matter to the effect that the name of the apparatus user who described the items on the design information sheet and the contents of the desired design is not disclosed for each item on the design information sheet and each content of the desired design. The processing of steps S437 to S449 are the same as those in steps S37 to S49 of FIG. 3A described in the first embodiment.

(c) Subsequently, in step S450, the server for exchanging design information 11 edits the common design data from the individual design data sent from each apparatus user. At this time, the server for exchanging design information 11 edits the common design data so that, with regard to the items on the design information sheet for which no apparatus user's name is set to be disclosed, the description column is not filled with the apparatus user's name or filled with symbols (codes) such as numerals and alphabets. The processing of steps S451 to S465 are the same as those of steps S51 to S65 of FIG. 3B described in the first embodiment.

(d) Next, in step S467, the apparatus maker prepares the reply to all of the items on the design information sheet in the common design data. At this time, matter to the effect that the name of the apparatus maker who replied to the items on the design information sheet is not disclosed is described. Processing of steps S469 to S479 are the same as those of steps S69 to S79 of FIG. 3B described in the first embodiment.

(e) Next, in step S480, the server for exchanging design information 11 edits the common design data, which has been replied to, into the individual design data. At this time, the server for exchanging design information 11 edits the individual design data so that, with regard to the items on the design information sheet which were set not to be disclosed, the description column is not filled with the apparatus maker's name or filled with symbols (codes) such as numerals and alphabets. The processing of steps S481 to S483 is the same as that in steps S81 to S83 of FIG. 3B described in the first embodiment.

When contact with system users who are not disclosed is desired, a request for information disclosure is made via the server for exchanging design information. When the closed system user agrees with the information disclosure, this system user tells of the intention to disclose the design information via the server for exchanging design information, and the design information is disclosed. However, the design information is disclosed only to the system user who made the request for information disclosure. In other words, one-user to one-user information exchange is performed.

According to the fourth embodiment, anonymousness in the information exchange is provided.

(Other Embodiments)

The present invention was described based on the foregoing first to fourth embodiments. The descriptions and the drawings forming part of the disclosure should not be understood as limiting the scope of the present invention. Based on this disclosure, various alternative embodiments, embodiments and implemented technologies will be clear to persons having ordinary skill in the art.

For example, in the first to fourth embodiments of the present invention, the semiconductor manufacturing apparatus was exemplified as the special design product, and the system for exchanging information relating to the design of semiconductor manufacturing apparatus are described. However, the exchanged design information can be applied not only to semiconductor manufacturing apparatus, but also to manufacturing apparatuses in other fields such as manufacturing apparatus for liquid crystals and optical recording mediums. Moreover, any system will do as long as the system concerns sophisticated and high-priced special design products, which include plants for chemical industries and steel industries other than manufacturing apparatuses, high performance machine tool of special design, analysis apparatuses for special purpose large scale computer, SIMS and RBS, and special purpose measurement instruments for measuring milli-wave and sub-milli-zones.

Furthermore, in the first to fourth embodiments of the present invention, description was made of the case where the authentication processing of the system user was executed both at the time when the server received notification of the access request and at the time when the server received the design data. However, the server may execute the authentication processing either at the time when the server received the notification of the access request or at the time when the server received the design data. The server may execute the authentication processing at other timings.

Moreover, though description of the case where the server for exchanging design information according to the first to fourth embodiments separately comprises the design data storage unit 15, the apparatus user data storage unit 16 and the apparatus maker data storage unit 17 was given, these storage units may be replaced by one storage unit. Similarly, through the description for the case where each module is incorporated in one central processing unit (CPU) 41, each module may be separately incorporated in a plurality of central processing units (CPU) 41. At this time, the central processing units (CPU) shall be connected to each other through buses so that data can be exchanged among the central processing units (CPU) 41.

In the method of exchanging design information according to the first to fourth embodiments of the present invention, the description of the case where the system user, the process name, the definition file and the like were registered was sequentially described in this order. However, the order of registration is not limited to the flow shown in FIG. 3A or FIG. 5. The order of registration may be different from that shown in FIG. 3A or FIG. 5, and it is not always necessary to register all of them every time information exchange is executed for one program name. For example, if the system user need not be registered after the system user is registered once, the system user need not be registered every time the design information described on the design information sheet is exchanged, and a new system user may be registered as occasion demands.

Various modifications will become possible for those skilled in the art after receiving the teachings of the present disclosures without departing from the scope thereof.

What is claimed is:

1. A server for exchanging design information, comprising:
an editing module configured to edit items of individual design data concerning the design information of special design products, which was transmitted from the terminal units of a plurality of apparatus users via a communication network, into one common design data, and to reedit replies to the plurality of common design data, which was transmitted from the terminal units of a plurality of apparatus makers, into individual design data of each apparatus user;
a comparison module configured to detect items on a design information sheet, which have been newly added to the individual design data; and
a design data storage unit configured to store the items on the design information sheet, which have been newly added separately from default items on a design information sheet.

2. The server of claim 1, further comprising:
a time processing module configured to stop an acceptance of the individual design data when an acceptance time of the individual design data from the terminal unit of the apparatus user previously registered has elapsed, and stop the acceptance of replies to the common design data when an acceptance time of replies to the common design data from the terminal unit of the apparatus maker previously registered has elapsed.

3. The server of claim 1, further comprising:
an authentication module configured to decide whether the terminal unit of the apparatus user who makes an access request has been previously registered in an apparatus user data storage unit, and decide whether the terminal unit of the apparatus maker who makes an access request has been previously registered in an apparatus maker data storage unit.

4. The server of claim 1, further comprising:
a registration module configured to store registration information about the apparatus user in an apparatus user data storage unit, and store registration information about the apparatus maker in an apparatus maker data storage unit.

5. The server of claim 1, further comprising:
an apparatus user data storage unit configured to store registration information about the apparatus user; and
an apparatus maker data storage unit configured to store registration information about the apparatus maker.

6. The server of claim 1, wherein the editing module edits the individual design data into common design data for each apparatus maker to be disclosed, with regard to items on a design information sheet for which setting of an apparatus maker's name to be disclosed is performed, and reedits the reply to the common design data into individual design data for each apparatus user to be disclosed, with regard to items on a design information sheet for which setting of an apparatus user's name is performed.

7. The server of claim 1, wherein with regard to items on a design information sheet on which a setting not to disclose an apparatus user's name is performed regarding the individual design data, the editing module edits the individual design data into common design data displaying the apparatus user's name by use of a blank column or a symbol, and with regard to items on a design information sheet on which a setting not to disclose an apparatus maker's name is performed in the reply to the common design data, and reedits the common design data to the individual design data displaying the apparatus maker's name by use of a blank column or a symbol.

8. A server for exchanging design information, comprising:
means for editing items of individual design data concerning the design information of special design products, which was transmitted from terminal units of a plurality of apparatus users via a communication network, into one common design data, and for reediting replies to the plurality of common design data, which was transmitted from the terminal units of a plurality of apparatus makers, into individual design data of each apparatus user;
means for detecting items on a design information sheet, which have been newly added on the individual design data; and
a design data storage unit for storing the items on the design information sheet, which have been newly added separately from default items on a design information sheet.

9. A method for exchanging design information, comprising:
registering a definition file concerning design information of a special design product in a design data storage unit;
detecting items on a design information sheet, which have been newly added to individual design data transmitted from a terminal unit of each of a plurality of apparatus users via a communication network, and sorting the newly added design items on the design information sheet to store them in the design data storage unit;
editing the individual design data transmitted from the terminal units of the plurality of apparatus users to one common design data;
receiving replies to the common design data from terminal units of a plurality of apparatus makers via the communication network; and
reediting the replies to the common design data into the individual design data of each apparatus user.

10. The method of claim 9, further comprising:
registering a period for accepting individual design data from the terminal unit of each of the plurality of apparatus users;
registering a period for accepting replies to the common design data from the terminal unit of each of the apparatus makers;
stopping an acceptance of the individual design data from the terminal units of each of the apparatus makers when the period for accepting individual design data has elapsed; and
stopping an acceptance of the replies to the common design data from the terminal unit of each apparatus maker when the period for accepting replies to the common design data has elapsed.

11. The method of claim 9, further comprising:
transmitting information for inquiring of the terminal unit of each apparatus user and the terminal of each apparatus maker as to whether they wish to take part in an information exchange;
receiving a response regarding participation in the information exchange from the terminal unit of each apparatus user and the terminal unit of each apparatus maker;
storing the terminal unit of each apparatus user and the terminal unit of the apparatus maker, who take part in the information exchange, in the apparatus user data storage unit and the apparatus maker data storage unit, respectively;
executing an authentication processing as to whether the participation of the apparatus user and the apparatus maker in the information exchange is registered in response to access from the terminal unit of each apparatus user and the terminal unit from the apparatus maker;
stopping acceptance of individual design data when individual design data has been received from all of the terminal units of the apparatus users registered; and
stopping acceptance of replies to the common design data when replies to the common design data have been received from all of the terminal units of the apparatus makers registered.

12. The method of claim 9, further comprising:
disclosing the contents of desired design for the items on the design information sheet only to a terminal unit of an apparatus maker described in a description column of a disclosed apparatus maker's name for each of the items on the design information sheet on the individual design data; and
disclosing a reply to the items on the design information sheet only to a terminal unit of an apparatus user described in a description column of a disclosed apparatus user's name for each of the design items on the design information sheet of common design data.

13. The method of claim 9, further comprising:
transmitting common design data which does not describe the apparatus user's name to the terminal unit of the apparatus maker with regard to the items on the design information sheet of the individual design data on which a setting not to disclose an apparatus user's name is performed; and
transmitting the individual design data which does not describe the apparatus maker's name to the terminal unit of the apparatus user with regard to the items on the design information sheet of the common design data on which a setting not to disclose an apparatus maker's name is performed.

14. A computer program product to be executed by a computer for controlling a design information exchange server, comprising:
instructions configured to register a definition file concerning design information of a special design product in a design data storage unit connected to the server;
instructions configured to detect items on a design information sheet, which are newly added on individual design data transmitted from a terminal unit of each of a plurality of apparatus users via a communication network, and to sort the newly added design items on the design information sheet to store them in the design data storage unit;
instructions configured to edit the individual design data transmitted from the terminal units of the plurality of apparatus users to one common design data;
instructions configured to receive replies to the common design data from terminal units from a plurality of apparatus makers via the communication network; and
instructions configured to reedit replies to the common design data into individual design data of each apparatus user.

15. The computer program product of claim 14, further comprising:
instructions configured to register a period for accepting individual design data from the terminal unit of each of the plurality of apparatus users;
instructions configured to register a period for accepting the replies to the common design data from the terminal unit of each of the apparatus makers;
instructions configured to stop acceptance of individual design data from the terminal units of each of the apparatus makers when the period for accepting the individual design data has elapsed; and
instructions configured to stop acceptance of the replies to the common design data from the terminal unit of each apparatus maker when the period for accepting replies to the common design data has elapsed.

16. The computer program product of claim 14, further comprising:
instructions configured to transmit information for inquiring of the terminal unit of each apparatus user and the terminal of each apparatus maker as to whether they wish to take part in an information exchange;
instructions configured to receive a response regarding participation in the information exchange from the terminal unit of each apparatus user and the terminal unit of each apparatus maker;
instructions configured to store the terminal unit of each apparatus user and the terminal unit of the apparatus maker, who take part in the information exchange, in the apparatus user data storage unit and the apparatus maker data storage unit, respectively;
instructions configured to execute an authentication processing as to whether the participation of the apparatus user and the apparatus maker in the information exchange is registered in response to access from the terminal unit of each apparatus user and the terminal unit from the apparatus maker;
instructions configured to stop acceptance of individual design data when individual design data has been received from all of the terminal units of the apparatus users registered; and
instructions configured to stop acceptance of replies to the common design data when replies to the common design data have been received from all of the terminal units of the apparatus makers registered.

17. The computer program product of claim 14, further comprising:
instructions configured to disclose the contents of desired design for the items on the design information sheet only to a terminal unit of an apparatus maker described in a description column of a disclosed apparatus maker's name for each of the items on the design information sheet on the individual design data; and
instructions configured to disclose a reply to items on the design information sheet only to a terminal unit of an apparatus user described in a description column of a disclosed apparatus user's name for each of the design items on the design information sheet of common design data.

18. The computer program product of claim 14, further comprising:
instructions configured to transmit common design data which does not describe the apparatus user's name to the terminal unit of the apparatus maker with regard to the items on the design information sheet of the individual design data on which a setting not to disclose an apparatus user's name is performed; and
instructions configured to transmit the individual design data which does not describe the apparatus maker's name to the terminal unit of the apparatus user with regard to the items on the design information sheet of the common design data on which a setting not to disclose an apparatus maker's name is performed.

19. A method for buying a special design product, comprising:
receiving a definition file concerning design information of a special design product registered in a server via a communication network by a terminal unit of an apparatus user;
transmitting individual design data in which contents of desired design are described for each item on the design information sheet on the definition file to the server via the communication network by the terminal unit of the apparatus user;
receiving a reply to the individual design data, which is transmitted from a terminal unit of an apparatus maker to the server, from the server via the communication network by the terminal unit of the apparatus user;
notifying of a wish to buy the special design product to the terminal unit of the apparatus maker via the server by the terminal unit of the apparatus user;
receiving an estimate sheet of the special design product meeting desired design of the apparatus user via the server by the terminal unit of the apparatus user; and
transmitting an order sheet corresponding to the estimate sheet to the apparatus maker via the server by the terminal unit of the apparatus user.

20. A method for selling a special design product, comprising:
receiving individual design data concerning design information of the special design product as common design data, which is edited and transmitted from a terminal unit of an apparatus user via a communication network, from the server via the communication network by a terminal unit of an apparatus maker;
transmitting a reply to the common design data to the server via the communication network, and transmitting data, which is obtained by reediting the reply into individual design data, to the terminal unit of the apparatus user via the server by the terminal unit of the apparatus maker;
receiving a estimate request of the special design product from the terminal unit of the apparatus user via the server by the terminal unit of the apparatus maker;
transmitting an estimate sheet for the special design product to the terminal unit of the apparatus user via the server by the terminal unit of the apparatus maker; and
receiving an order sheet transmitted from the terminal unit of the apparatus user via the server by the terminal unit of the apparatus maker.
